(19) United States
(12) Patent Application Publication
(10) Pub. No.: US 2005/0270963 A1
(43) Pub. Date: Dec. 8, 2005

(54) Optical recording medium

(75) Inventors: Koji Mishima, Tokyo (JP); Daisuke Yoshitoku, Tokyo (JP); Kenji Yamaga, Tokyo (JP); Junichi Satou, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: TDK Corporation, Tokyo (JP)

(21) Appl. No.: 11/144,768

(22) Filed: Jun. 6, 2005

(30) Foreign Application Priority Data
Jun. 4, 2004 (JP) P. 2004-167002
Jul. 14, 2004 (JP) P. 2004-207430

(51) Int. Cl. G11B 7/24

(52) U.S. Cl. 369/272.1; 369/283; 369/275.1

(57) ABSTRACT

An optical recording medium according to the invention has a disc body 11 in which a label side 11b can be viewed from a light incident side 11a, a printing layer 12 that is provided on the label side 11b of the disc body 11, and an ink receiving layer that is provided on the printing layer 12. Accordingly, the printed content of the printing layer 12 can be viewed from the light incident side 11a and a user can print a desired design on the ink receiving layer 13. Therefore, the design flexibility can be enhanced and a possibility of erroneous handling of the optical recording medium by the user can be drastically reduced. In addition, the optical recording medium by manufacturer or brand can be visually discriminated.

### BACKGROUND OF THE INVENTION

The present invention relates to an optical recording medium, and more particularly, it relates to an optical recording medium in which printing can be done on a label side opposite to a light incident side.

In recent years, as recording mediums for recording large digital data, optical recording mediums, such as the CD (Compact Disc), DVD (Digital Versatile Discs), and the like, have been widely used.

These optical recording mediums are broadly divided into ROM type optical recording mediums, such as the CD-ROM and DVD-ROM, that do not enable writing and rewriting of data, write-once type optical recording mediums, such as the CD-R and DVD-R, that enable writing but not rewriting of data, and data rewritable type optical recording mediums, such as the CD-RW and DVD-RW, that enable rewriting of data.

In particular, optical recording mediums on which data can be recorded by users are rapidly spreading. Since optical recording mediums capable of recording data are usable for simply preserving digital data, such as image data and musical data having large file sizes, at low cost, they have become utilized by a great deal of users. With the spread of such optical recording mediums, a demand for making original optical recording mediums by having data printed on sides opposite to light incident sides (hereinafter, referred to as ‘label side’) with printers is increasing and optical recording mediums capable of satisfying such a demand have already been developed and marketed.

In such an optical recording medium, an ‘ink receiving layer’ for fixing ink is provided on the label side, such that, printing can be done on the label side by using an ink-jet printer for supplying ink to the ink receiving layer (see JP-A-2002-237103).

However, in such an optical recording medium on which printing can be done on the label side thereof, the white ink receiving layer is provided on the most part of the label side, and thus there is no space for a design on the label side in advance. For this reason, a kind of an optical recording medium (write-once type or rewritable type), a manufacturer name, a brand name, and the like cannot be noticeably displayed. As a result, a user may erroneously operate the optical recording medium. Further, the optical recording medium by manufacturer or brand may not be discriminated visually.

Further, since a laser beam is used to record or reproduce data on these optical recording mediums, a ‘reflective layer’ is generally provided on the optical recording medium so as to reflect the laser beam. As a material for the reflective layer, a metal material having high reflectance, such as an alloy mainly containing aluminum (Al) or silver (Ag), or the like, has been widely used. For this reason, typically, the label side cannot be viewed from the light incident side (see JP-A-1-128234).

However, in a next-generation type optical recording medium in which a laser beam in a blue wavelength region is used, in view of the reflectance of the rewritable type optical recording medium, a material (oxide or the like), other than a metal, may be selected as the material for the reflective layer. In some cases, the reflective layer itself may be omitted. If a material having high transmittance is used as the material for the reflective layer or the reflective layer itself is omitted, transparency of a disc body becomes drastically high, such that the content printed on the label side can be easily viewed from the light incident side.

This allows a new design of an optical recording medium. In this case, however, the discrimination of the front and back sides is difficult and thus there is a risk of inserting an optical recording medium into a drive upside down.

### SUMMARY OF THE INVENTION

Accordingly, it is an object of the invention to provide an optical recording medium in which printing can be done on a label side opposite to a light incident side, thereby enhancing design flexibility.

Further, it is another object of the invention to provide an optical recording medium that can enhance design flexibility.

Further, it is still another object of the invention to provide an optical recording medium of which front and back sides can be easily discriminated, even when a disc body is substantially transparent.

According to an aspect of the invention, an optical recording medium includes a disc body in which a label side can be viewed from a light incident side, a printing layer that is provided on the label side of the disc body, and an ink receiving layer that is provided on the printing layer. As such, in the optical recording medium according to the aspect of the invention, the printing layer and the ink receiving layer are provided on the label side of the disc body in which the label side can be viewed from the light incident side. Thus, the printed content on the printing layer can be viewed from the light incident side and a user can print a desired design on the ink receiving layer. Therefore, design flexibility can be enhanced and a possibility of erroneous handling of the optical recording medium by the user can be drastically reduced. Further, the optical recording medium by manufacturer or brand can be discriminated visually.

In the optical recording medium according to the aspect of the invention, it is preferable that the mean roughness (Ra) of the surface of the ink receiving layer is equal to or less than 0.1 μm. According to this configuration, when printing is done with an ink-jet type printer, printing quality can be enhanced and so-called photographic image quality in terms of color development and gloss close to the quality of a film photo can be obtained.

In the optical recording medium according to the aspect of the invention, it is preferable that brightness of the ink receiving layer is equal to or more than 8 and chromaticity thereof is equal to or less than 4. If the brightness of the ink receiving layer is equal to or more than 8 and the chromaticity thereof is equal to or less than 4, the ink receiving layer is white or has a bright color close to white, such that an undercoat layer, such as white ink or the like, does not need to be interposed between the ink receiving layer and the disc body. As a result, a manufacturing process is simplified.

As colors having the brightness of 8 or more and the chromaticity of 4 or less, white (hue: N, brightness: 9.5, chromaticity: 0 (the expression by the Muncell color system is used and the same is applied to the followings)), snow white (hue: N, brightness: 9.5, chromaticity: 0), baby pink (hue: 4R, brightness: 8.5, chromaticity: 4.0), shell pink (hue: 10R, brightness: 8.5, chromaticity: 3.5), nail pink (hue: 10R, brightness: 8.0, chromaticity: 4.0), peach (hue: 3YR, brightness: 8.0, chromaticity: 3.5), ecru beige (hue: 7.5YR, brightness: 8.5, chromaticity: 4.0), leghorn (hue: 2.5Y, brightness: 8.0, chromaticity: 4.0), cream yellow (hue: 5Y, brightness: 8.5, chromaticity: 3.5), ivory (hue: 2.5Y, brightness: 8.5, chromaticity: 1.5), cool white (hue: 10PB, brightness: 9.5, chromaticity: 0.5), cherry blossom (hue: 10RP, brightness: 9.0, chromaticity: 2.5), and the like can be exemplified.

In the optical recording medium according to the aspect of the invention, it is preferable that the brightness of the ink receiving layer is equal to or more than 9 and the chromaticity thereof is equal to or less than 3. If the brightness of the ink receiving layer is equal to or more than 9 and the chromaticity thereof is equal to or less than 3, high printing quality can be achieved. As colors having the brightness of 9 or more and the chromaticity of 3 or less, white (hue: N, brightness: 9.5, chromaticity: 0), snow white (hue: N, brightness: 9.5, chromaticity: 0), cool white (hue: 10PB, brightness: 9.5, chromaticity: 0.5), cherry blossom (hue: 10RP, brightness: 9.0, chromaticity: 2.5), and the like can be exemplified.

In the optical recording medium according to the aspect of the invention, it is preferable that the brightness of the ink receiving layer is equal to or more than 9.2 and the chromaticity thereof is equal to or less than 0.5. If the brightness of the ink receiving layer is equal to or more than 9.2 and the chromaticity thereof is equal to or less than 0.5, higher printing quality can be achieved. As colors having the brightness of 9.2 or more and the chromaticity of 0.5 or less, white (hue: N, brightness: 9.5, chromaticity: 0), snow white (hue: N, brightness: 9.5, chromaticity: 0), cool white (hue: 10PB, brightness: 9.5, chromaticity: 0.5), and the like can be exemplified.

Further, the optical recording medium according to the aspect of the invention may further include an undercoat layer that is provided between the printing layer and the ink receiving layer. In this case, since the printing layer cannot be viewed transparent from the ink receiving layer, the ink receiving layer can be set to have a desired thickness.

It is preferable that the disc body has a light transmission substrate, a support substrate, and a functional layer that is provided between the light transmission substrate and the support substrate. Further, the light transmission substrate may have the substantially same thickness as that of the support substrate. An optical recording medium having such a structure is a so-called DVD type optical recording medium. Alternatively, it is preferable that the disc body has a light transmission layer, a support substrate, and a functional layer that is provided between the light transmission layer and the support substrate. Further, the light transmission layer may have a thickness thinner than that of the support substrate. An optical recording medium having such a structure is a next-generation type optical recording medium in which a laser beam in the blue wavelength region is used.

In this case, it is preferable that the functional layer has a recording layer on which data can be recorded. An optical recording medium having such a structure is a write-once type optical recording medium or a rewritable type optical recording medium. This is because a demand for printing on the label side by a user is increasing.

According to another aspect of the invention, an optical recording medium includes a disc body in which a label side can be viewed from a light incident side, and a label printing layer that is formed on the label surface of the disc body. The label printing layer has a first printing layer that can be viewed from the light incident side and a second printing layer that can be viewed from an opposite side to the light incident side.

In the optical recording medium according to another aspect of the invention, since at least two printing layers are provided on the label side of the transparent disc body, the front and back sides of the optical recording medium can be designed. For example, when the printed content of the first printing layer and the printed content of the second printing layer differ from each other, the front and back sides of the optical recording medium can have different designs. Further, if characters or figures for discriminating the front and back sides of the disc body are printed on at least one of the first and second printing layers, the front and back sides can be easily discriminated, even though the disc body is substantially transparent.

It is preferable that the label printing layer further has a shielding layer that is provided between the first printing layer and the second printing layer so as to reduce visibility of the printed content of the second printing layer from the light incident side and to reduce visibility of the printed content of the first printing layer from the opposite side to the light incident side. According to this configuration, even when a thickness of the first printing layer or the second printing layer is thin, desired design flexibility can be achieved and the front and back sides can be discriminated.

It is preferable that the disc body has a support substrate that has a spiral or concentric pit column formed on its one side and of which the other side constitutes the label side, a reflective layer that is provided so as to cover the one side of the support substrate, and a light transmission layer that is provided on the light incident side as viewed from the reflective layer. Such a disc body is a so-called next-generation read only (ROM type) disc. In this case, since required reflectance is low and high transparency is easily obtained, the invention is suitably applied thereto.

As such, according to the invention, design flexibility of a printable optical recording medium can be increased and a probability of erroneous handling of the optical recording medium by the user can be drastically reduced. Further, the optical recording medium by manufacturer can be discriminated visually.

Further, according to the invention, the front and back sides of the optical recording medium can be designed and thus design flexibility can be increased. Further, when the front and back sides of the optical recording medium have different designs, the disc body can be substantially transparent and the front and back sides can be easily discriminated.

### BRIEF DESCRIPTION OF THE DRAWINGS

FIG. 1 is a partially cut perspective view schematically showing an appearance of an optical recording medium 10 according to a preferred embodiment of the invention.

FIG. 2A is a cross-sectional view showing a structure of a disc body 11 of a next-generation type disc as an example.

FIG. 2B is a cross-sectional view showing a structure of a disc body 11 of a DVD type disc as another example.

FIG. 3 is a cross-sectional view schematically showing a configuration of a functional layer 22 in a ROM type disc.

FIG. 4 is a cross-sectional view schematically showing a configuration of a functional layer 22 in a write-once type disc.

FIG. 5 is a cross-sectional view schematically showing a configuration of a functional layer 22 in a rewritable type disc.

FIG. 6 is a partially cut perspective view schematically showing an appearance of an optical recording medium 40 according to another preferred embodiment of the invention.

FIG. 7 is a partially cut perspective view schematically showing an optical recording medium 110 according to a second embodiment of the invention.

FIG. 8 is a partially cut perspective view schematically showing an optical recording medium 140 according to another embodiment of the invention.

10, 40: OPTICAL RECORDING MEDIUM
11: DISC BODY
11a: LIGHT INCIDENT SIDE
11b: LABEL SIDE
12: PRINTING LAYER
13: INK RECEIVING LAYER
14: CENTER HOLE
21: SUPPORT SUBSTRATE
22, 33: FUNCTIONAL LAYER
22a: REFLECTIVE LAYER
22b: RECORDING LAYER
22c: DIELECTRIC LAYER
23: LIGHT TRANSMISSION LAYER
31: LIGHT TRANSMISSION SUBSTRATE
32: DUMMY SUBSTRATE
34: PROTECTIVE LAYER
35: ADHESIVE LAYER
41: UNDERCOAT LAYER

### DETAILED DESCRIPTION OF THE PREFERRED EMBODIMENTS

Hereinafter, preferred embodiments of the invention will be described in detail with reference to the accompanying drawings.

### First Embodiment

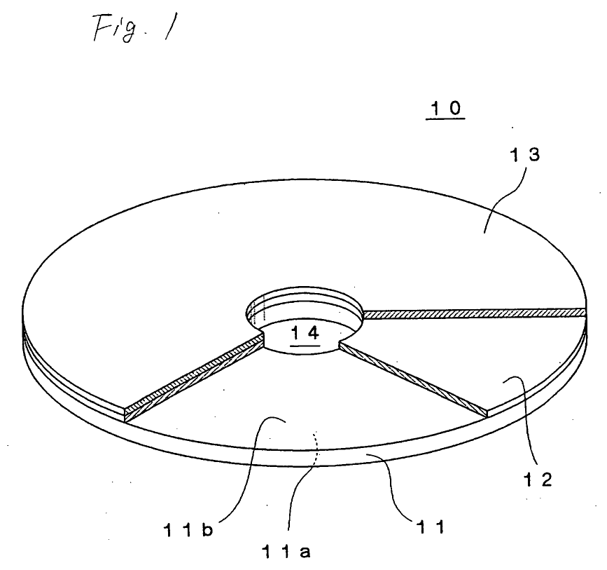

FIG. 1 is a partially cut perspective view schematically showing the appearance of an optical recording medium 10 according to a preferred embodiment of the invention.

The optical recording medium 10 according to the present embodiment is a disc-like optical recording medium having an outer diameter of about 120 mm and a thickness of about 1.2 mm. As shown in FIG. 1, the optical recording medium 10 includes a disc body 11, a printing layer 12 that is provided on a label side 11b of the disc body 11, and an ink receiving layer 13 that is provided on the printing layer 12. Further, a center hole 14 is provided at the center of the optical recording medium 10.

The disc body 11 has a light incident side 11a onto which a laser beam is irradiated when recording and/or reproducing, and the label side 11b that is a side opposite to the light incident side 11a. The disc body 11 has transparency to the extent that the label side 11b can be viewed from the light incident side 11a. The kinds of the disc body 11 are not particularly limited. For example, as the disc body 11, the CD type disc, such as the CD-ROM, CD-R, CD-RW, and the like, the DVD type disc, such as the DVD-ROM, DVD-R, DVD-RW, and the like, and a next-generation type optical disc in which a laser beam in the blue wavelength region is used can be used. However, in order to obtain the transparency to the extent that the label side 11b can be viewed from the light incident side 11a, the DVD type disc or the next-generation type optical disc is preferably used. Among them, in particular, the next-generation type optical disc is preferably used. This is because resultant reflectance is relatively low in the DVD type disc or the next-generation type optical disc, particularly, in the next-generation type optical disc.

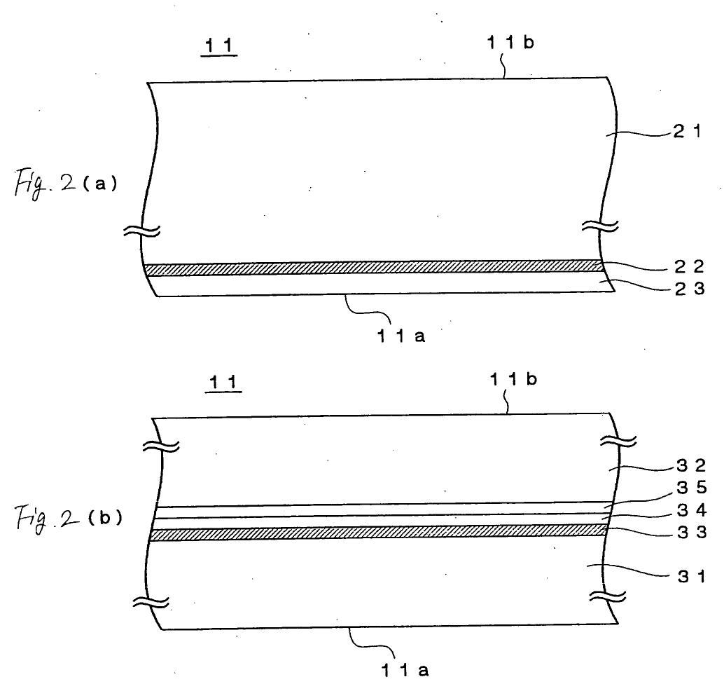

FIG. 2A is a cross-sectional view showing the disc body 11 of the next-generation type disc as an example to which the invention can be applied. FIG. 2B is a cross-sectional view showing the disc body 11 of the DVD type disc as another example to which the invention can be applied.

As shown in FIG. 2A, the next-generation type disc includes a support substrate 21 having a thickness of about 1.1 mm, one side of which constitutes the label side 11b, a functional layer 22 that is provided on the other side of the support substrate 21, and a light transmission layer 23, having a thickness of about 0.1 mm, that is provided so as to cover the functional layer 22. The surface of the light transmission layer 23 constitutes the light incident side 11a. Accordingly, when the next-generation type disc shown in FIG. 2A is used as the disc body 11, the printing layer 12 and the ink receiving layer 13 are provided on the surface of the support substrate 21 (the label side 11b).

In order to form the support substrate 21, a material that is transparent in the visible light region needs to be used. As the material that is transparent in the visible light region, resin, such as, polycarbonate resin, polyolefin resin, acrylic resin, epoxy resin, polystyrene resin, polyethylene resin, polypropylene resin, silicon resin, fluorocarbon resin, acrylonitrile butadiene styrene (ABS) resin, urethane resin, or the like, can be exemplified. Among these, in particularly, polycarbonate resin or polyolefin resin is most preferably used from the viewpoint of easy processing.

On the other hand, in order to form the light transmission layer 23, a material that is transparent in the visible light region and also is transparent in a wavelength region of a laser beam (for example, about 405 nm) needs to be used, since the light transmission layer 23 serves as an optical path of a laser beam irradiated when recording and/or reproducing. As such a material, acryl- or epoxy-based ultraviolet curable resin is preferably exemplified. Further, instead of a film that is formed by curing ultraviolet curable resin, the light transmission layer 23 may be formed by using a light transmission sheet made of light transmission resin and various bonding agents or adhesives.

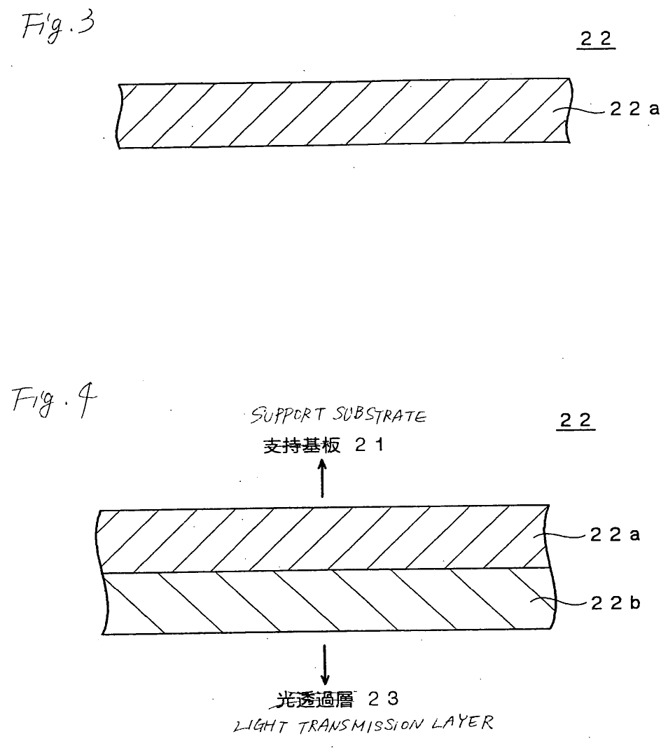

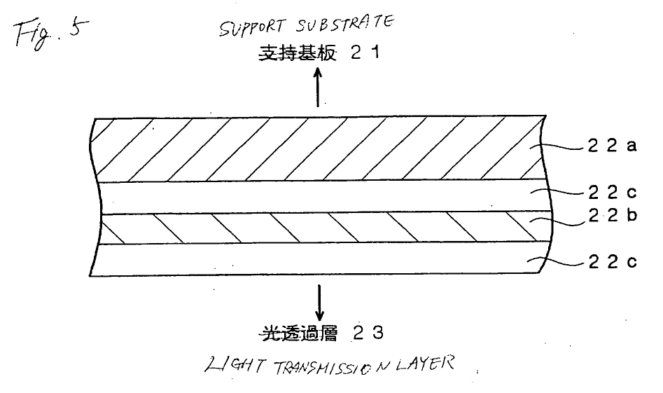

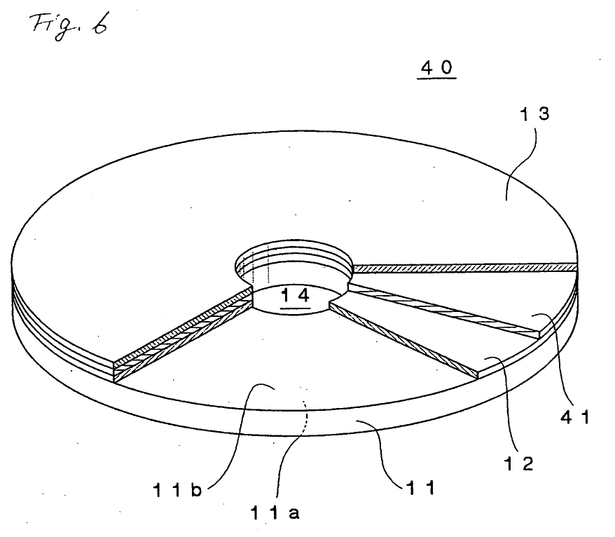

The structures or materials of the functional layers 22 differ from each other according to the kinds of the disc. That is, in the ROM type disc, as shown in FIG. 3, the functional layer 22 can be constituted by a reflective layer 22a. In the write-once type disc, as shown in FIG. 4, the functional layer 22 can be constituted by the reflective layer 22a and a recording layer 22b provided on the reflective layer 22a. Further, in the rewritable type disc, as shown in FIG. 5, the functional layer 22 can be constituted by the recording layer 22b, a plurality of dielectric layers 22c with the recording layer 22b interposed therebetween, and the reflective layer 22a. However, the optical recording medium according to the invention is an optical recording medium in which printing can be done on the label side. Accordingly, as regards the optical recording medium according to the invention, the write-once type disc (FIG. 4) or the rewritable type disc (FIG. 5) is preferably selected.

According to the invention, since the label side 11b needs to be viewed from the light incident side 11a, for any layer, a material having high transparency needs to be selected. Therefore, as for the reflective layer 22a, a metal material having high reflectance, such as an alloy mainly containing aluminum (Al) or silver (Ag), or a material having predetermined reflectance and high transmittance, such as silicon (Si) or titanium oxide (TiO₂), is selected. Alternatively, the reflective layer 22a may be omitted. As regards the recording layer 22b, in the write-once type disc, a material in which magnesium (Mg) and/or aluminum (Al) is added to a dielectric parent material (a mixture of ZnS and SiO₂) or a material mainly containing bismuth (Bi) and oxygen (O) is preferably used. In the rewritable type disc, a phase change material is preferably used. As regards the dielectric layer 22c, a transparent dielectric material, such as the mixture of ZnS and SiO₂, is preferably used. If these materials are selected, the disc body 11 is substantially transparent, such that the label side 11b can be viewed from the light incident side 11a. Moreover, the recording layer 22b mainly containing bismuth (Bi) and oxygen (O) becomes transparent when containing 63 atomic % of oxygen.

On the other hand, as shown in FIG. 2B, the DVD type disc has a light transmission substrate 31 having a thickness of about 0.6 mm, one side of which constitutes the light incident side 11a, a dummy substrate (support substrate) 32 having a thickness of about 0.6 mm, one side of which constitutes the label side 11b, a functional layer 33 that is provided on the other side of the light transmission substrate 31, a protective layer 34 that covers the functional layer 33, and a bonding agent 35 that bonds a laminate of the light transmission substrate 31, the functional layer 33, and the protective layer 34 to the dummy substrate 32. Therefore, when the DVD type disc shown in FIG. 2B is used as the disc body 11, the printing layer 12 and the ink receiving layer 13 are provided on the surface (the label side 11b) of the dummy substrate 32.

In order to form the light transmission substrate 31, a material that is transparent in the visible light region and also is transparent in a wavelength region of a laser beam (for example, about 650 nm) needs to be used. In order to form the dummy substrate 32, a material that is transparent in the visible light region needs to be used. As such a material, polycarbonate resin, polyolefin resin, or the like which is exemplified as the material for the support substrate 21, may be selected. Further, as regards the material for the protective layer 34 or the bonding agent 35, a material, such as ultraviolet curable resin, that is transparent in the visible light region, needs to be selected. The structures or materials of the functional layers 33 differ according to the kinds of the disc, like the next-generation type optical recording medium. In the write-once DVD type disc, such as the DVD-R, an organic dye is generally used as a material for the recording layer. Accordingly, it is considered that the invention is hard to be applied to the write-once DVD type disc.

Though not particularly limited, according to the invention, the next-generation type disc is most preferably selected as the disc body 11. This is because the next-generation type optical recording medium having a high recording density requires low reflectance and easily achieves high transparency.

Next, the printing layer 12 and the ink receiving layer 13 that are provided on the label side 11b of the disc body 11 will be described.

The printing layer 12 is a layer constituted by means of ink or the like and is provided in order to impart a desired design to the light incident side 11a via the disc body 11. However, since the printing layer 12 is covered with the ink receiving layer 13, that design cannot be viewed from the opposite side to the light incident side 11a. The printed content of the printing layer 12 is not particularly limited, but the kind of the optical recording medium or the manufacturer name, the brand name, and the like can be displayed. The printed content of the printing layer 12 can be viewed from the substantially entire surface of the light incident side 11a. Accordingly, design flexibility can be drastically increased and the kind of the optical recording medium or the manufacturer name, the brand name, and the like can be noticeably displayed. Therefore, a possibility of erroneous handling of the optical recording medium by a user can be drastically reduced and the optical recording medium by manufacturer or brand can be visually discriminated.

The ink receiving layer 13 is a layer that constitutes an outermost layer on one side of the optical recording medium 10 and serves to receive and fix ink supplied from an ink-jet type printer. In the present embodiment, the ink receiving layer 13 is colored white (hue: N, brightness: 9.5, chromaticity: 0) through the addition of a white pigment. The ink receiving layer 13 is preferably made of a material that mainly contains hydrophilic resin, such as polyvinyl alcohol or polyvinyl acetal, and that is mixed with cationic polymer or the like as an ink fixing agent. Further, as the white pigment to be added, titanium oxide, zinc oxide, aluminum oxide, aluminum hydroxide, white lead (basic lead carbonate), strontium titanate, calcium carbonate, mica, barium sulfate, silica, talc, kaolin clay, pyrophyllite, zeolite or the like is preferably exemplified. Among these, titanium oxide that has high refractive index and can perform color development with a small amount is most preferably selected.

A particle size of the white pigment may be fine from the viewpoint of the surface roughness. Specifically, the particle size is preferably in a range of from 0.1 to 1.0 μm. When titanium oxide is used as the white pigment, in particular, the particle size is preferable in a range of from 0.1 to 0.3 μm. The addition amount of the white pigment is preferably in a range of from 2 to 20 wt % with respect to resin. This is because, if the addition amount is less than 2 wt %, a whitening effect is sufficiently achieved and, if it exceeds 20 wt %, smoothness is decreased and curing by ultraviolet rays is hindered. Further, in order to color matching of white, other color development pigments, organic pigments, and dyes may also be used.

As the mean roughness (Ra) of the surface of the ink receiving layer 13 is small, printing quality, in particular, color development or gloss is enhanced when printing is done with a printer. In order to achieve a so-called photographic image quality in terms of color development or gloss close to quality of a film photo, the average roughness (Ra) of the surface of the ink receiving layer 13 is preferably equal to or less than 0.1 μm. The thickness of the ink receiving layer 13 is not particularly limited, but it is preferable in a range of from 10 μm to 30 μm.

The ink receiving layer 13 may be formed by means of a spin coating method or a slit coating method. As is well known, the spin coating method includes dropping an application liquid (a liquid prepared by diluting the material of the ink receiving layer 13 dissolved in a solvent with water or any other solvent) onto the center or the vicinity of the center of the surface (11b) of an object (the disc body 11) to be processed and turning the processing object whereby to spread the application liquid in the outer peripheral direction by centrifugal force. On the other hand, the slit coating method includes supplying an application liquid from a slit provided in a head and spreading the application liquid over the surface of an object to be processed by moving the relative position between the head and the object to be processed.

The reason for the use of the spin coating method or the slit coating method for forming the ink receiving layer 13 is that the mean roughness (Ra) of the surface can be made reducible by using one of these coating methods.

The application liquid used in the spin coating method or the slit coating method preferably uses water as the solvent, in addition to the above-described hydrophilic resin and the white pigment. Alternatively, in order to adjust solubility of resin or drying property of the coating film, a hydrophilic organic solvent, such as alcohol, or the like, mixed with the solvent may be used. When the hydrophilic organic solvent is mixed with the solvent, the concentration is preferably set in a range of from 20 to 100 wt % with respect to water of 720 wt %.

The concentration of the hydrophilic resin is preferably set in a range of from 80 to 90 wt % with respect to water of 720 wt % as the solvent. Further, the concentration of the white pigment is preferably set in a range of from 5 to 15 wt % with respect to water of 720 wt % as the solvent. If the concentrations of the hydrophilic resin and the white pigment are set in those ranges, at the time of spin coating or slit coating, the coating film having the uniform film thickness and high smoothness can be formed.

Further, a surface active agent is preferably added to the application liquid. The kind of the surface active agent may be suitably selected according to the kind of the white pigment or hydrophilic resin. The concentration of the surface active agent is preferably set in a range of from 0.1 to 0.5 wt % with respect to water of 720 wt % as the solvent.

Further, colloidal silica is preferably added to the application liquid. If colloidal silica is added, a gloss feeling can be imparted to the surface of the ink receiving layer 13. In this case, in order to achieve stability of a coating material, a cationic surface treatment is preferably performed on silica. The concentration of colloidal silica is preferably set in a range of from 20 to 30 wt % with respect to water of 720 wt % as the solvent.

If the spin coating method or the slit coating method is used, the distribution of the film thickness of the ink receiving layer 13 tends to grow larger, as compared to a screen printing method. However, if the above-described application liquid is used, a favorable coating film is formed, and thus the printing quality is hardly affected by the film thickness distribution.

When the ink receiving layer 13 is formed by the spin coating method or the slit coating method, the surface property of an underlying layer is greatly reflected on the formation of the ink receiving layer 13, unlike the case of using the screen printing method. That is, the mean roughness (Ra) of the underlying layer directly appears as the mean roughness (Ra) of the surface of the ink receiving layer 13. Therefore, if the mean roughness (Ra) of the surface of the printing layer 12 is set not greater than 0.1 μm, the mean roughness (Ra) of the surface of the ink receiving layer 13 can also be set not greater than 0.1 μm.

As described above, in the optical recording medium 10 according to the present embodiment, the printing layer 12 and the ink receiving layer 13 are formed on the label side 11b of the transparent disc body 11. Accordingly, the printed content of the printing layer 12 can be viewed from the light incident side 11a and the user can print a desired design on the ink receiving layer 13. Therefore, the design flexibility can be enhanced and a possibility of erroneous handling of an optical recording medium by a user can be drastically reduced. Further, an optical recording medium by manufacturer or brand can be visually discriminated.

Further, in the optical recording medium 10 according to the present embodiment, since the ink receiving layer 13 itself is colored white, an undercoat layer, such as white ink, or the like, does not need to be interposed between the ink receiving layer 13 and the printing layer 12. As a result, the manufacturing process can be simplified.

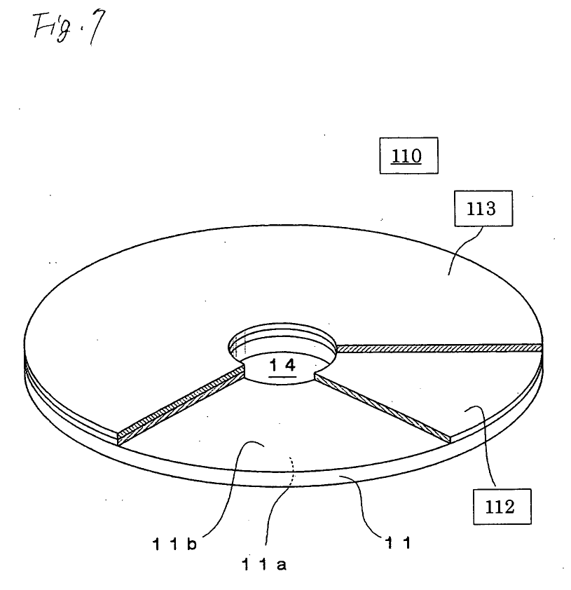

FIG. 6 is a partially cut perspective view schematically showing the appearance of an optical recording medium 40 according to another preferred embodiment of the invention.

The optical recording medium 40 according to the present embodiment is different from the optical recording medium 10 according to the above-described embodiment in that an undercoat layer 41 is provided between the printing layer 12 and the ink receiving layer 13. Other parts are the same as those of the optical recording medium 10. The same parts as those of the optical recording medium 10 are represented by the same reference numerals and the descriptions thereof will be omitted.

The undercoat layer 41 is an undercoat of the ink receiving layer 13. The undercoat layer 41 is provided in order to improve color development primarily, thereby increasing the printing quality. Therefore, in the optical recording medium 40 according to the present embodiment, the ink receiving layer 13 does not need to be colored white. The ink receiving layer 13 may be transparent.

As a material for the undercoat layer 41, ultraviolet curable resin, in particular, ultraviolet curable acrylic resin having low shrinkage factor is preferably used. In the present embodiment, this material is colored white (hue: N, brightness: 9.5, chromaticity: 0) through the addition of a white pigment. As the white pigment to be added, a preferred material as the white pigment added to the ink receiving layer 31 of the optical recording medium 10 according to the above-described embodiment can be exemplified. The particle size or the addition amount of the white pigment is the same.

The mean roughness (Ra) of the surface of the undercoat layer 41 is preferably equal to or less then 0.1 μm. Accordingly, the mean roughness (Ra) of the surface of the ink receiving layer 13 that is provided on the surface of the undercoat layer 41 can also be easily equal to or less then 0.1 μm.

As such, in the optical recording medium 40 according to the present embodiment, the undercoat layer 41 is provided between the printing layer 12 and the ink receiving layer 13. Accordingly, the printing layer 12 can be reliably prevented from being viewed transparent from the ink receiving layer 13. Accordingly, the ink receiving layer 13 can be set to have a desired thickness.

The invention is not limited to the embodiments described above but may include various changes and modifications within the scope of the invention as hereinafter claimed and such changes and modifications are needless to say intended to be within the scope thereof.

For example, though the printing layer 12 is formed directly on the label side 11b of the disc body 11 in the respective embodiments, another layer may be interposed between the label side 11b of the disc body 11 and the printing layer 12 insofar as visibility from the light incident side 11a is not damaged.

Further, though the ink receiving layer 13 or the undercoat layer 41 is colored white through the addition of the white pigment in the respective embodiments, the ink receiving layer 13 or the undercoat layer 41 itself may be constituted by using a white material so as to have brightness of 8 or more and chromaticity of 4 or less, without the addition of the white pigment.

In addition, though the optical recording mediums 10 and 40 according to the respective embodiments have disc shapes having the thickness of about 1.2 mm and the diameter of about 120 mm, the invention is not limited to these optical recording mediums 10 and 20. Further, the appearance of the optical recording medium not necessarily has the disc shape. The light incident side 11a or the label side 11b may have a rectangular shape.

### Second Embodiment

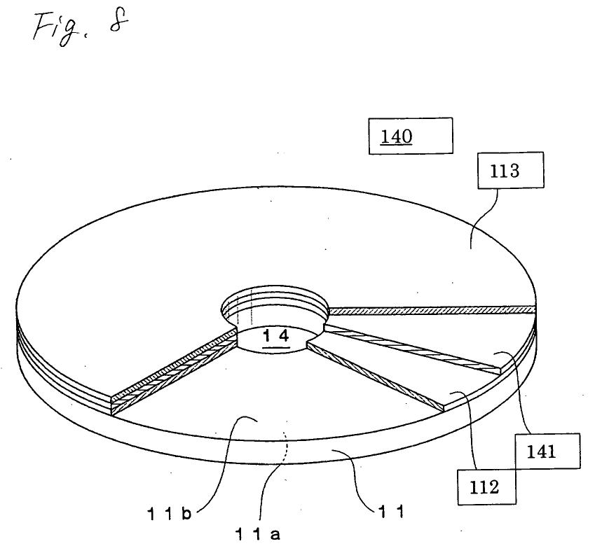

FIG. 7 is a partially cut perspective view schematically showing an optical recording medium 110 according to a second embodiment of the invention.

The optical recording medium 110 according to the present embodiment is a disc-like optical recording medium having an outer diameter of about 120 mm and a thickness of about 1.2 mm. As described above, the optical recording medium 110 has a disc body 11, a first printing layer 112 that is provided on a label side 11b of the disc body 11, and a second printing layer 113 that is provided on the first printing layer 112. Further, a center hole 14 is formed at the center of the optical recording medium 110. Moreover, according to the invention, a plurality of layers provided on the label side of the disc body (in the present embodiment, the first printing layer 112 and the second printing layer 113) are collectively referred to as ‘label printing layer’. Other parts, excluding the first printing layer 112 and the second printing layer 113, are the same as those of the first embodiment, and the descriptions thereof will be omitted.

Though not particularly limited, according to the invention, a next-generation type read only (ROM type) disc is most preferably selected as the disc body 11. This is because the next-generation type optical recording medium having the high recording density requires low reflectance and the read only disc can be constituted with the minimum number of layers. When the next-generation type read only disc is adopted as the disc body 11, a spiral or concentric pit column is formed on the opposite side to the label side 11b of the support substrate 21, such that data is stored.

Next, the first printing layer 112 and the second printing layer 113 provided on the label side 11b of the disc body 11 will be described.

Each of the first printing layer 112 and the second printing layer 113 is a layer constituted by ink or the like. Of the first printing layer 112 and the second printing layer 113, the first printing layer 112 is provided in order to view from the light incident side 11a. Further, the second printing layer 113 is provided in order to view from the opposite side to the light incident side 11a. Accordingly, the front and back sides of the optical recording medium 110 can be designed differently from each other.

The printed contents of the first printing layer 112 and the second printing layer 113 are not particularly limited. For example, if the optical recording medium 110 according to the present embodiment is a ROM type optical recording medium and records a movie, on the first printing layer 112, one scene, a simple story, actors, and the like of that movie may be printed. Further, on the second printing layer 113, a package design, including a movie title and the like, may be printed. Further, if music is recorded, on the first printing layer 112, words of music may be printed and, on the second printing layer 113, a package design, including an album title, an artist name, or the like, may be printed. As such, since the printed content of the first printing layer 112 and the printed content of the second printing layer 113 can differ from each other, the front and back sides having different designs can be realized, which is a problem inherent in the related art.

Further, in addition to realizing design flexibility, characters or figures for identifying the front and back sides may be printed on the first printing layer 112 and/or the second printing layer 113. That is, in the optical recording medium 110 according to the present embodiment, the disc body 11 is substantially transparent. Accordingly, when printing is not done on the entire surface of the label side 11b or only one printing layer is provided, the front and back sides cannot be easily discriminated. For this reason, there may be a risk of inserting the optical recording medium 110 into a drive upside down. In order to prevent this risk effectively, for example, the characters of ‘this is a recording side’ is printed on the first printing layer 112 or the figures for identifying the front and back sides may be printed on one or both of the first printing layer 112 and the second printing layer 113. For example, it is effective that a x mark is printed on the first printing layer 112 and a O mark is printed on the second printing layer 113.

In addition, it can be considered that the entire surface of the first printing layer 112 is printed with a single color and a predetermined design is printed on the second printing layer 113. According to this configuration, the design printed on the second printing layer 113 cannot be viewed from the light incident side 11a. Accordingly, even when the disc body 11 is substantially transparent, the substantially same design as that of the optical recording medium according to the related art is realized. Accordingly, the risk of erroneous handling of the front and back sides by the user can be drastically reduced.

As described above, in the optical recording medium 110 according to the present embodiment, two printing layers (112, 113) are provided on the label side 11b of the transparent disc body 11, such that the front and back sides of the optical recording medium 110 can have different designs. For this reason, the design flexibility can be enhanced and, even when the disc body 11 is substantially transparent, the front and back sides can be easily discriminated.

FIG. 8 is a partially cut perspective view schematically showing the appearance of an optical recording medium 140 according to another preferred embodiment of the invention.

The optical recording medium 140 according to the present embodiment is different from the above-described embodiment in that a shielding layer 141 is provided between the first printing layer 112 and the second printing layer 113. Other parts, excluding the shielding layer 141, are the same as those of the optical recording medium 110. The same parts as those of the optical recording medium 110 are represented by the same reference numerals, and the descriptions thereof will be omitted.

The shielding layer 141 is, for example, a layer whose entire surface is colored with a single color (white or the like). The shielding layer 141 serves to decrease the visibility of the second printing layer 113 from the light incident side 11a and decrease the visibility of the first printing layer 112 from the opposite side to the light incident side 11a. That is, when the thickness of the first printing layer 112 or the second printing layer 113 is thin, the printed content of the second printing layer 113 may be viewed from the light incident side 11a or the printed content of the first printing layer 112 may be viewed from the opposite side to the light incident side 11a. In this case, the desired design flexibility may not be clearly achieved or the discrimination of the front and back sides may be difficult. The shielding layer 141 is provided so as to solve this problem. By providing the shielding layer 141, even when the thickness of the first printing layer 112 or the second printing layer 113 is thin, the desired design flexibility can be clearly achieved and the front and back sides can be easily discriminated.

The invention is not limited to the embodiments described above but may include various changes and modifications within the scope of the invention as hereinafter claimed and such changes and modifications are needless to say intended to be within the scope thereof.

For example, though the first printing layer 112 is formed directly on the label side 11b of the disc body 11 in the respective embodiments, another layer may be interposed between the label side 11b of the disc body 11 and the first printing layer 112 insofar as the visibility from the light incident side 11a is not damaged. Similarly, though the second printing layer 113 constitutes the outermost layer of each of the optical recording medium 110 and 140 in the respective embodiments, another layer may be disposed on the second printing layer 13, insofar as the visibility from the opposite side to the light incident side 11a is not damaged.

Further, according to the invention, the printed contents of the first printing layer 112 and the second printing layer 113 are not necessarily different from each other. For example, the printed content of the first printing layer 112 as viewed from the light incident side 11a is identical to the printed content of the second printing layer 113 as viewed from the opposite side to the light incident side 11a. Accordingly, the optical recording medium having the front and back sides of the same design can be constituted.

In addition, though the optical recording mediums 110 and 140 according to the respective embodiments have disc shapes having the thickness of about 1.2 mm and the diameter of about 120 mm, the invention is not limited to these optical recording mediums 110 and 140. Further, the appearance of the optical recording medium not necessarily has the disc shape. The light incident side 11a or the label side 11b may have a rectangular shape.

### EXAMPLES

A description will now be given of examples of the invention, which is not limited in any way to the following examples thereof, however.

### Example 1

An optical recording medium having the same structure as that of the optical recording medium shown in FIG. 1 was produced by the following method. With respect the disc body, the disc having the structure shown in FIG. 2A was used.

First, a disc-like support substrate made of polycarbonate and having a thickness of about 1.1 mm and a diameter of about 120 mm was prepared by means of an injection molding method. On the surface of the support substrate, lands and grooves were formed. The depth of the groove was set to about 21 nm and the width of the groove was set to about 169 nm. The track pitch was set to about 320 nm.

Next, the support substrate was set on a sputtering device and the recording layer having a thickness of 32 nm was film-formed on the surface having the lands and the grooves by the sputtering method using a mixed target mainly containing ZnS and SiO₂ and a target mainly containing magnesium (Mg). The compositions of Zn, Si, Mg, 0, and S contained in the recording layer are 21.5, 10.1, 20.8, 20.1, and 27.5 atomic %, respectively. The analysis of these compositions was performed with a fluorescent X-ray analyzer ZSX 100e available from RIGAKU CORPORATION.

Next, acryl-based ultraviolet curable resin was coated on the recording layer by the spin coating method and was subjected to the ultraviolet irradiation, thereby forming the light transmission layer having the thickness of about 100 μm. The disc body produced in such a manner was substantially transparent.

Then, the printing layer was formed on the label side of the disc body by the screen printing method and the ink receiving layer was formed on the surface of the printing layer by the slit coating method. The printed content of the printing layer can be viewed clearly from the light incident side, but, since the ink receiving layer is non-transparent, the printed content of the printing layer cannot be viewed via the ink receiving layer. The formation condition of the ink receiving layer is as follows.

First, titanium oxide A-190 of 10 wt % as the white pigment (available from SAKAI CHEMICAL), polyvinyl alcohol of 85 wt % as the hydrophilic resin, Snowtex AK of 25 wt % as the colloidal silica (available from NISSAN CHEMICAL), a surface active agent of 0.2 wt % (available from NIPPON OIL & FATS), and water and isopropyl alcohol of 720 wt % and 40 wt %, respectively, as a solvent were mixed and the application liquid was adjusted accordingly. At the time of the adjustment of the application liquid, first, the hydrophilic resin (polyvinyl alcohol) was dissolved in water, the remnants were added, and then mixing and stirring were performed.

Next, with a slit coating device, the application liquid was coated on the surface of the printing layer. The slit width of the slit coating device was set to 0.08 mm in the innermost circumferential portion and to 0.12 mm in the outermost circumferential portion. Then, slit coating was performed in a range of from 20 mm to 58 mm radius from the center of the disc body, while rotating the disc body at 14 rpm. Then, the coating film was leveled by rotating the disc body for 15 seconds at 100 rpm and was dried at 80° C. for 5 minutes. Accordingly, the ink receiving layer having a thickness of 20 μm was formed.

With measuring the hue, brightness, chromaticity of the ink receiving layer formed in such a manner, the hue was N, the brightness was 9.5, and the chromaticity was 0. Further, as the measurement result, the surface roughness (Ra) was about 0.05 μm.

Further, when printing was done on the ink receiving layer with the ink-jet type printer, the color development or gloss close to the film photo can be achieved.

### Example 2

In the formation of the recording layer, the optical recording medium of the Example 2 was produced, similarly to the Example 1, except that sputtering was performed using a mixed target mainly containing LaSiON (a mixture of La₂O₃, SiO₂, and Si₃N₄) and a target mainly containing magnesium (Mg). The thickness of the recording layer was about 32 nm and the compositions of La, Si, Mg, O, and N contained in the recording layer were 6.2, 24.1, 23.1, 24.6, and 22.0 atomic %, respectively. The disc body was substantially transparent, like the disc body constituting the optical recording medium of the Example 1.

In the optical recording medium of the Example 2, the printed content of the printing layer can be viewed clearly from the light incident side. However, since the ink receiving layer is non-transparent, the printed content of the printing layer cannot be viewed via the ink receiving layer.

### Example 3

In the formation of the recording layer, the optical recording medium of the Example 3 was produced, similarly to the Example 1, except that sputtering was performed using a target mainly containing bismuth (Bi) under an argon and nitrogen atmosphere. The thickness of the recording layer was about 45 nm and the compositions of Bi and O contained in the recording layer were 27 atomic % and 73 atomic %, respectively. The disc body was substantially transparent, like the disc body constituting the optical recording medium of the Example 1.

In the optical recording medium of the Example 3, the printed content of the printing layer can be viewed clearly from the light incident side. However, since the ink receiving layer is non-transparent, the printed content of the printing layer cannot be viewed via the ink receiving layer.

1. An optical recording medium comprising:
a disc body in which a label side is viewable from a light incident side;
a printing layer that is provided on the label side of the disc body; and
an ink receiving layer that is provided on the printing layer.

2. The optical recording medium according to claim 1, wherein an average roughness (Ra) of a surface of the ink receiving layer is equal to or less than 0.1 μm.

3. The optical recording medium according to claim 1, wherein a brightness of the ink receiving layer is 8 or more and a chromaticity thereof is 4 or less.

4. The optical recording medium according to claim 2, wherein a brightness of the ink receiving layer is 8 or more and a chromaticity thereof is 4 or less.

5. The optical recording medium according to claim 1 further comprising:
an undercoat layer that is provided between the printing layer and the ink receiving layer.

6. The optical recording medium according to claim 2 further comprising:
an undercoat layer that is provided between the printing layer and the ink receiving layer.

7. An optical recording medium comprising:
a disk body in which a label side is viewable from a light incident side; and
a label printing layer that is formed on the label side of the disc body, the label printing layer including a first printing layer that is viewable from the light incident side and a second printing layer that is viewable from an opposite side to the light incident side.

8. The optical recording medium according to claim 7, wherein a printed content of the first printing layer and a printed content of the second printing layer are different from each other.

9. The optical recording medium according to claim 8, wherein, on at least one of the first and second printing layers, characters or figures for identifying front and back sides of the disc body are printed.

10. An optical recording medium according to claim 7, wherein the label printing layer further includes a shielding layer that is provided between the first printing layer and the second printing layer, and reduce visibility of a printed content of the second printing layer from the light incident side and reduce visibility of a printed content of the first printing layer from an opposite side to the light incident side.

11. The optical recording medium according to claim 7, wherein the disc body has a support substrate, one side on of which has a spiral or concentric pit column and the other side of which constitutes the label side, a reflective layer that is provided so as to cover the one side of the support substrate, and a light transmission layer that is provided on the light incident side as viewed from the reflective layer.
